(19) United States
(12) Patent Application Publication
(10) Pub. No.: US 2018/0338168 A1
(43) Pub. Date: Nov. 22, 2018

(54) SPLICING IN ADAPTIVE BIT RATE (ABR) VIDEO STREAMS

(71) Applicant: ARRIS Enterprises LLC, Suwanee, GA (US)

(72) Inventor: Thomas L. Du Breuil, Ivyland, PA (US)

(21) Appl. No.: 15/985,112

(22) Filed: May 21, 2018

Related U.S. Application Data
(60) Provisional application No. 62/508,753, filed on May 19, 2017.

(51) Int. Cl. H04N 21/234; H04L 29/06; H04N 21/2343

(52) U.S. Cl. CPC H04N 21/23424; H04L 65/607; H04N 21/234345; H04L 65/80; H04L 65/601

(57) ABSTRACT

A method is provided for providing splice points in a video stream for encoding the video. The primary video stream has one or more splice points denoted therein at which a secondary video stream is to be inserted. The primary stream is encoded using a model of a hypothetical decoder input buffer that assigns a predetermined buffer occupancy level to the hypothetical decoder input buffer at each of the splice points.

### Cross Reference to Related Application

This application claims priority to U.S. Provisional Application Ser. No. 62/508,753, filed May 19, 2017, entitled “Ad Splicing” in ABR Streams, the contents of which are incorporated herein by reference.

### BACKGROUND

An internet protocol video delivery network based on adaptive streaming techniques can provide many advantages over traditional cable delivery systems, such as greater flexibility, reliability, lower integration costs, new services, and new features. However, with the evolution of internet protocol video delivery networks comes a modified architecture for the adaptive bit rate delivery of multimedia content to subscribers. For example, traditional cable operators using legacy delivery networks (e.g., Quadrature Amplitude Modulation based) are trading or supplementing the use of digital controllers, switched digital video systems, video on demand pumps, and edge Quadrature Amplitude Modulation (QAM) devices with smarter encoders, a content delivery network, and cable modem termination systems (CMTS).

The process of inserting advertisements into adaptive video streams is complicated because of the need to first identify a suitable exit point in a first encoded digital stream, and then to align this exit point with a suitable entrance point into a second encoded digital stream. Typically, ad insertion is accomplished by manifest manipulation such that no video stream conditioning is performed on the inserted content before it reaches the client. As a consequence, there may be discontinuities in various parameters such as the Program Clock Reference (PCR) and the Presentation Time Stamp (PTS). In addition, the Video Buffer Verifier (VBV) may deviate from its expected value and thus the decoder buffer in the client may overflow or underflow. These problems are avoided by conditioning the ABR stream before the ads have been inserted to simplify MPEG processing for the client decoder.

### SUMMARY

In accordance with one aspect of the present disclosure, a method and apparatus for encoding a video stream is provided. In accordance with the method, a primary video stream is received. The primary video stream has one or more splice points denoted therein at which a secondary video stream is to be inserted. The primary video stream is encoded using a model of a hypothetical decoder input buffer that assigns a predetermined buffer occupancy level to the hypothetical decoder input buffer at each of the splice points. In one particular embodiment, the primary and secondary video streams are adaptive bit rate (ABR) video streams.

In accordance with another aspect of the present disclosure, the secondary video stream is encoded using the same hypothetical decoder input buffer model that is used to encode the primary video stream such that the same predetermined buffer occupancy level is assigned at a beginning point and end point of the secondary video stream. By encoding both the primary and secondary video streams with an agreed upon buffer occupancy level, the decoder buffer will not underflow or overflow.

### BRIEF DESCRIPTION OF THE DRAWINGS

FIG. 1 depicts a high level illustration of a representative adaptive bit rate system that delivers content to adaptive bit rate client devices via an internet protocol content delivery network.

FIG. 2 illustrates in more detail some of the components of the adaptive bit rate system shown in FIG. 1.

FIG. 3 is a simplified a block diagram illustrating the relationship between an encoder, an encoder buffer, a decoder, a decoder buffer, and a data channel over which the encoder and decoder communicate.

FIG. 4 shows one example of an encoder that may employ the video buffer verifier (VBV) model described herein.

FIG. 5 illustrates a block diagram of one example of a computing apparatus that may be configured to implement or execute one or more of the processes required to encode and/or transcode an ABR bit stream using the techniques described herein.

### DETAILED DESCRIPTION

Described herein are techniques by which an encoder or transcoder can ensure that a client receiving an adaptive bit rate (ABR) video stream will not encounter overflow or underflow of its decoder buffer at a splice point without the need for reprocessing the entire ABR stream. The terms encoder and transcoder are used interchangeably herein.

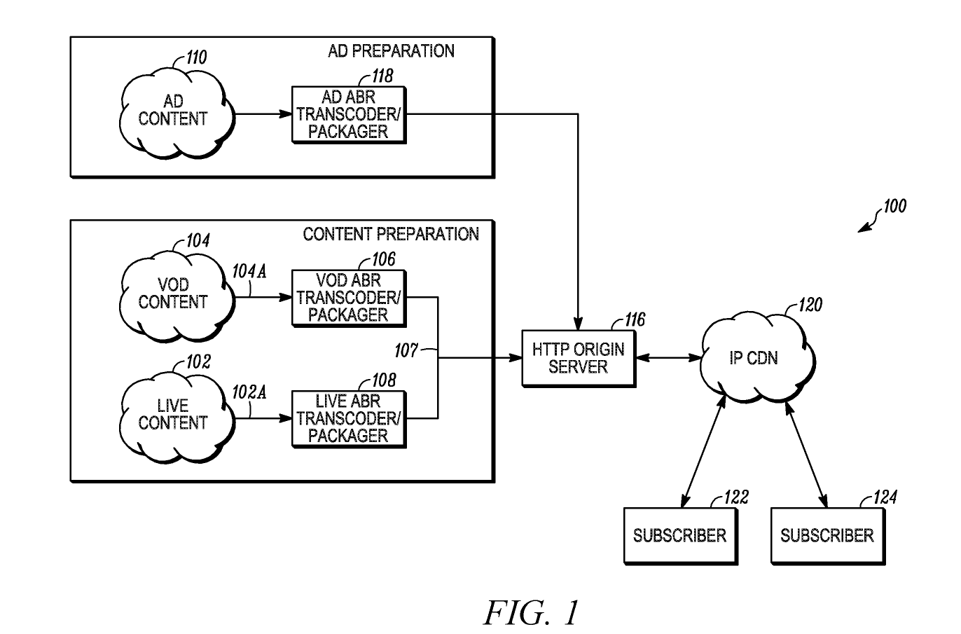

FIG. 1 depicts a high level illustration of a representative adaptive bit rate system 100 that delivers content to adaptive bit rate client devices 122 and 124 via an internet protocol content delivery network 120. An adaptive bit rate client device is a client device capable of providing streaming playback by requesting an appropriate series of segments from an adaptive bit rate system 100 over the internet protocol content delivery network (CDN) 120. The representative adaptive bit rate client devices 122 and 124 shown in FIG. 1 are associated with subscribers such as subscribers 122 and 124. The content provided to the adaptive bit rate system 100 may originate from a content source such as live content source 102 or video on demand (VOD) content source 104.

An adaptive bit rate system, such as the adaptive bit rate system 100 shown in FIG. 1, uses adaptive streaming to deliver content to its subscribers. Adaptive streaming, also known as ABR streaming, is a delivery method for streaming video using an Internet Protocol (IP). As used herein, streaming media includes media received by and presented to an end-user while being delivered by a streaming provider using adaptive bit rate streaming methods. Streaming media refers to the delivery method of the medium, e.g., http, rather than to the medium itself. The distinction is usually applied to media that are distributed over telecommunications networks, e.g., “on-line,” as most other delivery systems are either inherently streaming (e.g., radio, television) or inherently non-streaming (e.g., books, video cassettes, audio CDs). Hereinafter, on-line media and on-line streaming using adaptive bit rate methods are included in the references to “media” and “streaming.”

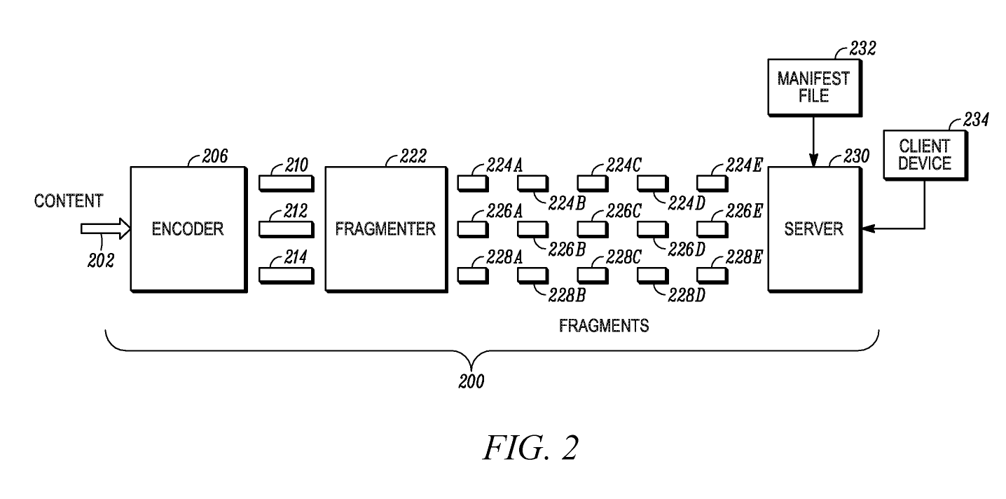

Adaptive bit rate streaming, discussed in more detail below with respect to FIG. 2, is a technique for streaming multimedia where the source content is encoded at multiple bit rates. It is based on a series of short progressive content files applicable to the delivery of both live and on demand content. Adaptive bit rate streaming works by breaking the overall media stream into a sequence of small file downloads, each download loading one short segment, or chunk, of an overall potentially unbounded content stream.

As used herein, a chunk is a small file containing a short video segment (typically 2 to 10 seconds) along with associated audio and other data. Sometimes, the associated audio and other data are in their own small files, separate from the video files and requested and processed by the client(s) where they are reassembled into a rendition of the original content. Adaptive streaming may use the Hypertext Transfer Protocol (HTTP) as the transport protocol for these video chunks. For example, ‘chunks’ or chunk files' may be short sections of media retrieved in an HTTP request by an adaptive bit rate client. In some cases these chunks may be standalone files, or may be sections (i.e. byte ranges) of one much larger file. For simplicity the term ‘chunk’ is used to refer to both of these cases (many small files or fewer large files).

The example adaptive bit rate system 100 depicted in FIG. 1 includes live content source 102, VOD content source 104, ad content source 110, HTTP and origin server 116,. . The components between the live content source 102, VOD content source 104 and ad content source 110 and the IP content delivery network 120 in the adaptive bit rate system 100 (e.g., ABR transcoder/packagers 106, 108, 118 and origin server 116) may be located in a headend, production facility or other suitable location within a content provider network. A cable television headend is a master facility for receiving television signals for processing and distributing content over a cable television system. The headend typically is a regional or local hub that is part of a larger service provider distribution system, such as a cable television distribution system. An example is a cable provider that distributes television programs to subscribers, often through a network of headends or nodes, via radio frequency (RF) signals transmitted through coaxial cables or light pulses through fiber-optic cables.

The adaptive bit rate system 100 receives content from a content source, represented by the live content source 102 and VOD content source 104. The live content source 102, VOD content source 104 and ad content source 110 represents any number of possible cable or content provider networks and manners for distributing content (e.g., satellite, fiber, the Internet, etc.). The illustrative content sources 102, 104 and 110 are non-limiting examples of content sources for adaptive bit rate streaming, which may include any number of multiple service operators (MSOs), such as cable and broadband service providers who provide both cable and Internet services to subscribers, and operate content delivery networks in which Internet Protocol (IP) is used for delivery of television programming (i.e., IPTV) over a digital packet-switched network.

Examples of a content delivery network 120 include networks comprising, for example, managed origin and edge servers or edge cache/streaming servers. The content delivery servers, such as edge cache/streaming server, deliver content and manifest files to IP subscribers 122 or 124. In an illustrative example, content delivery network 120 comprises an access network that includes communication links connecting origin servers to the access network, and communication links connecting distribution nodes and/or content delivery servers to the access network. Each distribution node and/or content delivery server can be connected to one or more adaptive bit rate client devices; e.g., for exchanging data with and delivering content downstream to the connected IP client devices. The access network and communication links of content delivery network 120 can include, for example, a transmission medium such as an optical fiber, a coaxial cable, or other suitable transmission media or wireless telecommunications. In an exemplary embodiment, content delivery network 120 comprises a hybrid fiber coaxial (HFC) network.

The adaptive bit rate client device associated with a user or a subscriber may include a wide range of devices, including digital televisions, digital direct broadcast systems, wireless broadcast systems, personal digital assistants (PDAs), laptop or desktop computers, digital cameras, digital recording devices, digital media players, video gaming devices, video game consoles, cellular or satellite radio telephones, video teleconferencing devices, and the like. Digital video devices implement video compression techniques, such as those described in the standards defined by ITU-T H.263 (MPEG-2) or ITU-T H.264/MPEG-4, Part 10, Advanced Video Coding (AVC), the High Efficiency Video Coding (HEVC) standard, and extensions of such standards, to transmit and receive digital video information more efficiently. More generally, any suitable standardized or proprietary compression techniques may be employed.

As shown in FIG. 1, the adaptive bit rate system 100 may deliver live content 102a to one or more subscribers 122, 124 over an IP CDN 120 via a path that includes a adaptive bit rate transcoder/packager 108 and an origin server 116. Likewise, the adaptive bit rate system 100 may deliver VOD content 104a to the one or more subscribers 122, 124 over the IP CDN 120 via a path that includes an adaptive bit rate transcoder/packager 106 and the origin server 116. Generally, an adaptive bit rate transcoder/packager is responsible for preparing individual adaptive bit rate streams. A transcoder/packager is designed to encode, then fragment, or “chunk,” media files and to encapsulate those files in a container expected by the particular type of adaptive bit rate client. Thus, a whole video may be segmented in to what is commonly referred to as chunks or adaptive bit rate fragments/segments. The adaptive bit rate fragments are available at different bit rates, where the fragment boundaries are aligned across the different bit rates so that clients can switch between bit rates seamlessly at fragment boundaries. The adaptive bit rate system generates or identifies the media segments of the requested media content as streaming media content.

Along with the delivery of media, the packager creates and delivers manifest files. As shown in FIG. 1, the transcoder/packagers 106 and 108 deliver media and manifest files 107 to the origin server 116. The packager creates the manifest files as the packager performs the chunking operation for each type of adaptive bit rate streaming method. In adaptive bit rate protocols, the manifest files generated may include a variant playlist and a playlist file. The variant playlist describes the various formats (resolution, bit rate, codec, etc.) that are available for a given asset or content stream. For each format, a corresponding playlist file may be provided. The playlist file identifies the media file chunks/segments that are available to the client. It is noted that the terms manifest files and playlist files may be referred to interchangeably herein. The client determines which format the client desires, as listed in the variant playlist, finds the corresponding manifest/playlist file name and location, and then retrieves media segments referenced in the manifest/playlist file.

Similarly, content provided by ad content source 110 is prepared by ABR transcoder packager 118 as shown in FIG. 1. The ABR transcoder packager 118 delivers the media segments and manifest files for this content to the origin server 116. In some implementations, there may be a separate origin server for ad content than is used for the live or VOD content and these origin servers may be in different geographic locations.

The ABR transcoder/packagers create the manifest files to be compliant with an adaptive bit rate streaming format of the associated media and also compliant with encryption of media content under various DRM schemes. Thus, the construction of manifest files varies based on the actual adaptive bit rate protocol. Adaptive bit rate streaming methods have been implemented in proprietary formats including HTTP Live Streaming (“HLS”) by Apple, Inc., and HTTP Smooth Streaming by Microsoft, Inc. adaptive bit rate streaming has been standardized as ISO/IEC 23009-1, Information Technology-Dynamic Adaptive Streaming over HTTP (“DASH”): Part 1: Media presentation description and segment formats. Although references are made herein to these example adaptive bit rate protocols, it will be recognized by a person having ordinary skill in the art that other standards, protocols, and techniques for adaptive streaming may be used.

In HLS, for example, the adaptive bit rate system 100 receives a media request from a subscriber and generates or fetches a manifest file to send to the subscriber's playback device in response to the request. A manifest file can include links to media files as relative or absolute paths to a location on a local file system or as a network address, such as a URI path. In HLS, an extended m3u format is used as a non-limiting example to illustrate the principles of manifest files including non-standard variants.

The ABR transcoder/packagers 106 and 108 post the adaptive bit rate chunks associated with the generated manifest file to origin server 116. Thus, the origin server 116 receives video or multimedia content from one or more content sources via the ABR transcoders/packagers 106 and 108. The origin server 116 may include a storage device where audiovisual content resides, or may be communicatively linked to such storage devices; in either case, the origin server 116 is a location from which the content can be accessed by the adaptive bit rate client devices 122, 124. The origin server 116 may be deployed to deliver content that does not originate locally in response to a session manager.

As shown in FIG. 1, the content delivery network (CDN) 120 is communicatively coupled to the origin servers 116 and to one or more distribution nodes and/or content delivery servers (e.g., edge servers, or edge cache/streaming servers). The subscriber or consumer, via a respective client device, is responsible for retrieving the media file chunks,' or portions of media files, from the origin server 116 as needed to support the subscriber's desired playback operations. The subscriber may submit the request for content via the internet protocol content delivery network (CDN) 120 that can deliver adaptive bit rate file segments from the service provider or headend to end-user adaptive bit rate client devices.

Playback at the adaptive bit rate client device of the content in an adaptive bit rate environment, therefore, is enabled by the playlist or manifest file that directs the adaptive bit rate client device to the media segment locations, such as a series of uniform resource identifiers (URIs). For example, each URI in a manifest file is usable by the client to request a single HTTP chunk. The manifest file may reference live content or on demand content. Other metadata also may accompany the manifest file.

At the start of a streaming session, the adaptive bit rate client device 122, 124 receives the manifest file containing metadata for the various sub-streams which are available. Upon receiving the manifest file, the subscriber's client device 122, 124 parses the manifest file and determines the chunks to request based on the playlist in the manifest file, the client's own capabilities/resources, and available network bandwidth. The adaptive bit rate client device 122, 124 can fetch a first media segment posted to an origin server for playback. For example, the user may use HTTP Get requests to request media segments. Then, during playback of that media segment, the playback device may fetch a next media segment for playback after the first media segment, and so on until the end of the media content. This process continues for as long as the asset is being played (until the asset completes or the user tunes away). Note that for live content especially, the manifest file will continually be updated as live media is being made available. These live playlists may also be referred to as sliding window playlists.

The use of an adaptive bit rate system that chunks media files allows the client to switch between different quality (size) chunks of a given asset, as dictated by network performance. The client has the capability by using the manifest file, to request specific fragments/segments at a specific bit rate. As the stream is played, the client device may select from the different alternate streams containing the same material encoded at a variety of data rates, allowing the streaming session to adapt to the available network data rate. For example, if, in the middle of a session, network performance becomes more sluggish, the client is able to switch to the lower quality stream and retrieve a smaller chunk. Conversely, if network performance improves the client is also free to switch back to the higher quality chunks.

Since adaptive bit rate media segments are available on the adaptive bit rate system in one of several bit rates, the client may switch bit rates at the media segment boundaries. Using the manifest file to adaptively request media segments allows the client to gauge network congestion and apply other heuristics to determine the optimal bit rate at which to request the media presentation segments/fragments from one instance in time to another. As conditions change the client is able to request subsequent fragments/segments at higher or lower bitrates. Thus, the client can adjust its request for the next segment. The result is a system that can dynamically adjust to varying network congestion levels. Often, the quality of the video stream streamed to a client device is adjusted in real time based on the bandwidth and CPU of the client device. For example, the client may measure the available bandwidth and request an adaptive bit rate media segment that best matches a measured available bit rate. Because the chunks, or fragments, are aligned in time across the available bit rate offerings, switching between them can be performed seamlessly to the viewer.

FIG. 2 illustrates in more detail some of the components of the adaptive bit rate system shown in FIG. 1. In this example the ABR transcoder/packager 200 (e.g., ABR transcoder/packagers 106 and 108 in FIG. 1) includes an encoder 206 and a fragmenter 222. Also shown is origin server 230 (e.g., HTTP origin server 116 in FIG. 1) The transcoder/packager 200 outputs a manifest file 232 for adaptive bit rate metadata. The adaptive bit rate system delivers the manifest file 232 and corresponding content using adaptive bit rate techniques to an adaptive bit rate client device 234.

As shown in FIG. 2, the content stream 202 may be input to encoder 206. The encoder 206 converts whole content streams in to multiple streams at different bit rates. For example, an encoder is responsible for taking an MPEG stream (e.g., MPEG-2/MPEG-4) or a stored MPEG stream (e.g., MPEG-2/MPEG-4), encoding it digitally, encapsulating it in MPEG-2 single program transport streams (SPTS) at multiple bit rates, and preparing the encapsulated media for distribution. The content stream 202 may be encoded into any number of transport streams, each having a different bit rate. In the example of FIG. 2 three transport streams 210, 212, 214 are shown for purposes of illustration. The content stream 202 may be a broadcast of multimedia content from a content provider. Alternatively, the content stream may be, for example, on demand content or other content.

The resultant transport streams 210, 212, 214 are directed to a fragmenter 222. The fragmenter 222 reads each encoded stream 210, 212, 214 and divides them into a series of fragments of a finite duration. For example, MPEG streams may be divided into a series of 2-3 second fragments with multiple wrappers for the various adaptive streaming formats (e.g., Microsoft Smooth Streaming, APPLE HLS). As shown in FIG. 2, the transport streams 210, 212, 214, are fragmented by fragmenter 222 into adaptive bit rate media segments 224a-e, 226a-e, and 228a-e, respectively.

The fragmenter 222 can generate a manifest file that represents a playlist. The playlist can be a manifest file that lists the locations of the fragments of the multimedia content. By way of a non-limiting example, the manifest file can comprise a uniform resource locator (URL) for each fragment of the multimedia content. If encrypted, the manifest file can also include the content key used to encrypt the fragments of the multimedia content.

The content received by the encoder from a content source generally contains indicators specifying splice points indicating where in the content stream an ad or other programming is to be inserted. In the case of program substitution and advertisement insertion for an MPEG-2 transport stream, for instance, in-band SCTE35 markers as defined by the Society of Cable and Telecommunications Engineers (SCTE) are generally provided. In particular, a content generator will specify points during at which advertisements may be inserted. The locations at which these points occur may be known in advance, or they may be variable as in the case of sporting and other live events.

As used herein, advertisements refer to any content that interrupts the primary content that is of interest to the viewer. Accordingly, advertising can include but is not limited to, content supplied by a sponsor, the service provider, or any other party, which is intended to inform the viewer about a product or service. For instance, public service announcements, station identifiers and the like are also referred to as advertising.

It should be noted that while for purposes of illustration the examples described herein refer to ad insertion into an ABR stream, more generally the techniques and systems described herein are applicable whenever a first ABR stream is interrupted at a splice point at which a second ABR stream is spliced or otherwise inserted. Such splice points may be specified in accordance with any suitable technique such as the aforementioned SCTE35 markers in the case of advertising.

Splice points, as specified by SCTE35 markers or the like, generally do not align with the segments of an ABR stream. Accordingly, when the encoder receives an indication that a splice point is to occur at a certain location, it will place a segment boundary at that location in the ABR stream. Accordingly, while ABR segments are typically equal in duration, the last segment before a splice point and the first segment after a splice point ad might be shorter or longer than normal in duration to accommodate the insertion of the ad or other stream that is to be inserted. In this way the location of a splice point is made to align with an ABR segment boundary.

As previously mentioned, one problem that can arise when an ABR stream is interrupted to insert an ad is that the decoder buffer may underflow or overflow. As explained below, this may occur despite the use of an encoder that employs a video buffer verifier (VBV) model and a decoder that conforms to the same encoding standard as the encoder.

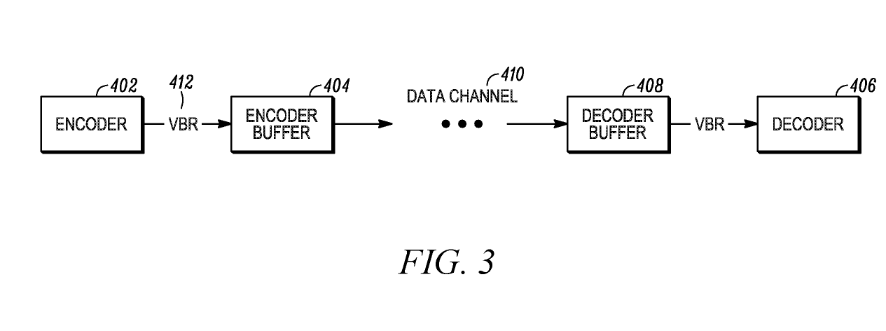

FIG. 3 is a simplified a block diagram illustrating the relationship between an encoder 402, an encoder buffer 404, a decoder 406, a decoder buffer 408, and a data channel 410 over which the encoder 402 and decoder 406 communicate. The encoder 402 receives and encodes content and can output a variable bit rate (VBR) output 412. The variable bit rate output 412 is temporarily stored in the encoder buffer 404. A function of the encoder buffer 404 and the decoder buffer 408 is to hold data temporarily such that data can be stored and retrieved at different data rates.

Video encoding standards such as MPEG-2, AVC and HEVC, for example, employ a hypothetical reference decoder or video buffer verifier (VBV) model for modeling the transmission of encoded video data from the encoder to the decoder. The VBV is a mechanism by which an encoder and a corresponding decoder avoid overflow and/or underflow in the video buffer of the decoder. The VBV generally imposes constraints on variations in bit rate over time in an encoded bit stream with respect to timing and buffering. For example, H.264 specifies a 30 Mbit buffer at level 4.0 in the decoder of an HD channel. In addition, the encoder keeps a running track of the amount of video data that it forwards to the decoder. If the VBV is improperly managed, the video buffer of the decoder could underflow, which occurs when the video runs out of video to display. In this scenario, the viewing experience involves dead time. In addition, the VBV may overflow, which occurs when the decoder buffer cannot hold all the data it receives. In this scenario, the excess data is discarded and the viewing experience is similar to an instant fast-forward that jumps forward in the video. Both scenarios are disruptive to the viewing experience. Note also that both video underflow and overflow cause video corruption. Video corruption can persist for the entire group of pictures (GOP) since subsequent frames in that GOP use the past anchor frames (I and P) as reference. It should be noted that the encoder buffer 404 is a different buffer from the video buffer verifier (VBV) buffer, which is used by the encoder 402 to model the occupancy of the decoder buffer 408 during the encoding process.

When an ad is to be inserted into an ABR stream the segments of the original stream are replaced with the segments of another ABR stream. While a discontinuity indicator may inform the decoder that a new stream (corresponding e.g., to the advertisement) is being transmitted, the decoder does not flush its buffer but rather continues to buffer any remaining data from the original ABR stream. Even though the encoder that encoded the new stream may employ the same VBV model as the encoder that encoded the original stream, the new stream does not know the current status of the decoder. As a consequence, the decoder buffer may actually contain more data or less data than the VBV model employed by the encoder of the new stream anticipates. This may lead to an underrun or overrun of the decoder buffer even though both ABR streams (the original stream and the stream being spliced) have been encoded using the same VBV model.

To address this problem, the VBV buffer model may assume that some predetermined fraction of the VBV buffer is filled with data whenever a splice point is reached. The predetermined fraction is greater than zero but less than 1. That is, the VBV buffer is neither assumed to be completely empty or completely full. For instance, the VBV buffer may be assumed to be ¼ full, ⅓ full, ½ full, or ¾ full whenever a splice point is reached. In some embodiments the VBV buffer may be assumed to a fullness level somewhere between 0.25-0.75 of its maximum capacity. This VBV buffer model will be used by the encoder that encodes the primary ABR stream into which an ad or other secondary ABR stream is to be inserted. This same VBV buffer model will also be used by the encoder that encodes the ad or other secondary stream where it will set the start of the first segment and the end of the last segment at this same VBV fullness level of the ad or other secondary content. In this way when the secondary stream is spliced into the primary stream, both encoders will have agreed as to how much data is currently located in the VBV model and thus both will encode their respective ABR streams using the same assumption concerning the fullness of the decoder buffer.

By encoding both the primary and secondary ABR streams with an agreed upon VBV buffer fullness as described above, the decoder buffer will not underflow or overflow, thus enabling the decoder to continuing operating and displaying video cleanly for the viewer. The precise occupancy level that is assigned to the VBV buffer at the splice point can be chosen to both optimize encoding quality while minimizing the likelihood of decoder underflow/overflow during an error condition such as a lost packet in transmission. E.g., using a VBV buffer setting very near 0/empty or 1/full is undesirable since it would provide little margin in the presence of transmission errors.

The techniques described herein provided a cost effective and scalable method for inserting ad or other secondary ABR video streams into a primary ABR video stream. These techniques may also be used when ABR video streams are converted back to MPEG transport streams at the network edge in order to support legacy delivery techniques such as QAM-based techniques that deliver the content to legacy devices such as set top boxes.

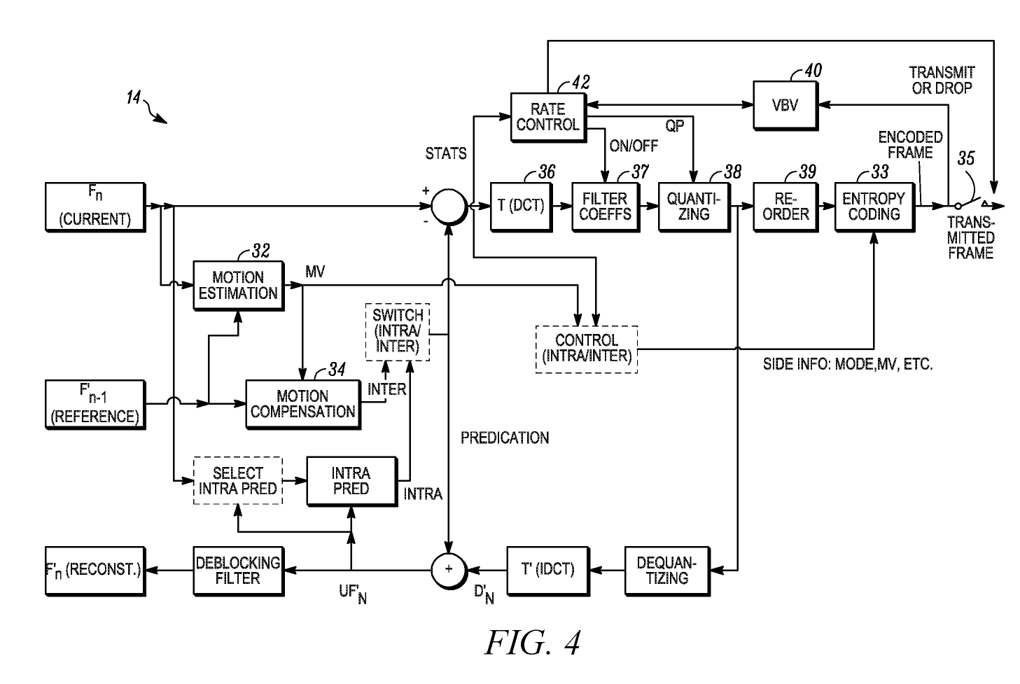

FIG. 4 shows one example of an encoder that may employ the VBV model described herein. The encoder 14 includes a motion estimation module 32, a motion compensation module 34, a transform module 36, generally a DCT as is the case for H.263 and MPEG-4 encoding, a quantizing module 38, a rate control device 42, a coefficient filtering module 37, and a video buffering verifier 40. The motion estimation module 32 predicts an area or areas of the previous frame that have moved into the current frame so that this or these areas do not need to be re-encoded. Then, the motion compensation module 34 compensates for the movement of the above predicted area(s), detected by the motion estimation module 32, from a reference frame (generally the previous frame) into the current frame. This will enable the encoder 14 to compress and save bandwidth by encoding and transmitting only differences between the previous and current frames, thereby producing an Inter frame.

The transform module 36 performs a transformation on blocks of pixels of the successive frames. The transformation depends on the video coding standard technology. In the case of H.263 and MPEG-4, it is a DCT transformation of blocks of pixels of the successive frames. In the case of H.264, the transformation is a DCT-based transformation or a Hadamar transform. The transformation can be made upon the whole frame (Intra frames) or on differences between frames (Inter frames). DCTs are generally used for transforming blocks of pixels into “spatial frequency coefficients” (DCT coefficients). They operate on a two-dimensional block of pixels, such as a macroblock (MB). Since DCTs are efficient at compacting pictures, generally a few DCT coefficients are sufficient for recreating the original picture.

The transformed coefficients are then supplied to the filter coefficient module 37, in which the transformed coefficients are filtered. For example, the filter coefficient module 37 sets some coefficients, corresponding to high frequency information for instance, to zero. The filter coefficient module 37 improves the performance of the rate control device 42 in case of small target frame sizes.

The filtered transformed coefficients are then supplied to the quantizing module 38, in which they are quantized. For example, the quantizing module 38 sets the near zero filtered DCT coefficients to zero and quantizes the remaining non-zero filtered DCT coefficients. A reorder module 39 then positions the quantized coefficients in a specific order in order to create long sequences of zeros. An entropy coding module 33 then encodes the reordered quantized DCT coefficients using, for example, Huffman coding or any other suitable coding scheme. In this manner, the entropy coding module 33 produces and outputs coded Intra or Inter frames.

The video buffering verifier (VBV) 40 is then used to validate that the frames transmitted to the decoder will not lead to an overflow of the receiving buffer of this decoder. If a frame will not lead to an overflow, the rate control device 42 will allow the transmission of the frame through the switch 35. However, if a frame will lead to an overflow, the rate control device 42 will not allow the transmission of the frame, and will cause the path of 36, 37, 38, 38 and 33 to reprocess the frame to reduce its size. In this way the rate control device 42 allows for controlling the bitrate in video coding.

Additional components of the encoder shown in FIG. 4 are conventional encoder components used for performing temporal and spatial prediction and for estimating motion vectors for temporal prediction and hence do not need to be discussed in detail.

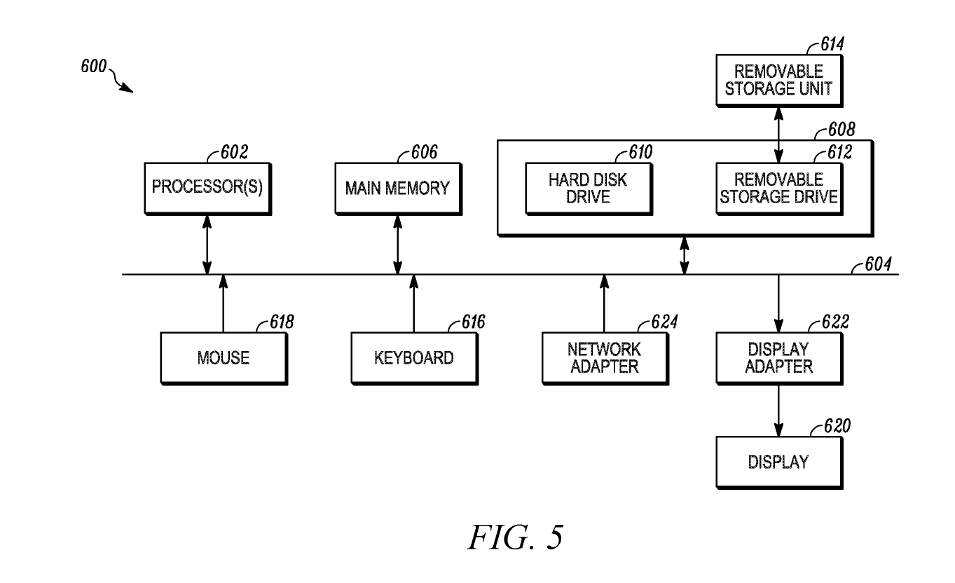

FIG. 5 illustrates a block diagram of one example of a computing apparatus 600 that may be configured to implement or execute one or more of the processes required to encode and/or transcode an ABR bit stream using the techniques described herein. It should be understood that the illustration of the computing apparatus 600 is a generalized illustration and that the computing apparatus 600 may include additional components and that some of the components described may be removed and/or modified without departing from a scope of the computing apparatus 600.

The computing apparatus 600 includes a processor 602 that may implement or execute some or all of the steps described in the methods described herein. Commands and data from the processor 602 are communicated over a communication bus 604. The computing apparatus 600 also includes a main memory 606, such as a random access memory (RAM), where the program code for the processor 602, may be executed during runtime, and a secondary memory 608. The secondary memory 608 includes, for example, one or more hard disk drives 410 and/or a removable storage drive 612, where a copy of the program code for one or more of the processes depicted in FIGS. 2-5 may be stored. The removable storage drive 612 reads from and/or writes to a removable storage unit 614 in a well-known manner.

As disclosed herein, the term “memory,” “memory unit,” “storage drive or unit” or the like may represent one or more devices for storing data, including read-only memory (ROM), random access memory (RAM), magnetic RAM, core memory, magnetic disk storage mediums, optical storage mediums, flash memory devices, or other computer-readable storage media for storing information. The term “computer-readable storage medium” includes, but is not limited to, portable or fixed storage devices, optical storage devices, a SIM card, other smart cards, and various other mediums capable of storing, containing, or carrying instructions or data. However, computer readable storage media do not include transitory forms of storage such as propagating signals, for example.

User input and output devices may include a keyboard 616, a mouse 618, and a display 620. A display adaptor 622 may interface with the communication bus 604 and the display 620 and may receive display data from the processor 602 and convert the display data into display commands for the display 620. In addition, the processor(s) 602 may communicate over a network, for instance, the Internet, LAN, etc., through a network adaptor 624.

Although described specifically throughout the entirety of the instant disclosure, representative embodiments of the present invention have utility over a wide range of applications, and the above discussion is not intended and should not be construed to be limiting, but is offered as an illustrative discussion of aspects of the invention.

What has been described and illustrated herein are embodiments of the invention along with some of their variations. The terms, descriptions and figures used herein are set forth by way of illustration only and are not meant as limitations. Those skilled in the art will recognize that many variations are possible within the spirit and scope of the embodiments of the invention.

1. A method of encoding a video stream, comprising:
receiving a primary video stream having one or more splice points denoted therein at which a secondary video stream is to be inserted; and
encoding the primary video stream using a model of a hypothetical decoder input buffer that assigns a predetermined buffer occupancy level to the hypothetical decoder input buffer at each of the splice points.

2. The method of claim 1, wherein the primary video stream is an adaptive bit rate (ABR) video stream.

3. The method of claim 2, wherein the splice points are aligned with ABR segment boundaries.

4. The method of claim 1, wherein the hypothetical decoder input buffer model is a video buffer verifier (VBV) buffer model that prevents buffer overflow or underflow in a decoder buffer of a decoder that conforms to a compression standard used to encode the primary video stream.

5. The method of claim 1, wherein the predetermined occupancy level is 0.25-0.75 of a maximum capacity of the hypothetical decoder input buffer.

6. The method of claim 1, further comprising encoding a secondary video stream using the hypothetical decoder input buffer model that is used to encode the primary video stream such that the same predetermined buffer occupancy level is assigned at a beginning point and end point of the secondary video stream.

7. The method of claim 1, further comprising selecting the predetermined occupancy level assigned to the hypothetical decoder input buffer such that overflow or underflow does not occur in the hypothetical decoder input buffer when encoding the primary and secondary video streams.

8. The method of claim 1, wherein the splice point is denoted by an SCTE35 marker.

9. A non-transitory computer-readable storage media containing instructions which, when executed by one or more processors perform a method comprising:
receiving a primary ABR video stream that is to be divided into a plurality of ABR segments; and
encoding the primary video stream using a model of a hypothetical decoder input buffer that assigns a predetermined buffer occupancy level to the hypothetical decoder input buffer at each ABR segment boundary.

10. The non-transitory computer-readable storage media of claim 9, wherein the primary video stream has one or more splice points each located at one of the ABR segment boundaries.

11. The non-transitory computer-readable storage media of claim 9, wherein the hypothetical decoder input buffer model is a VBV buffer model that prevents buffer overflow or underflow in a decoder buffer of a decoder that conforms to a compression standard used to encode the primary video stream.

12. The non-transitory computer-readable storage media of claim 9, wherein the predetermined occupancy level is 0.25-0.75 of a maximum capacity of the hypothetical decoder input buffer.

13. The non-transitory computer-readable storage media of claim 9, further comprising encoding a secondary video stream using the hypothetical decoder input buffer model that is used to encode the primary video stream such that the predetermined buffer occupancy level is assigned at a beginning point and end point of the secondary video stream.

14. The non-transitory computer-readable storage media of claim 9, further comprising selecting the predetermined occupancy level assigned to the hypothetical decoder input buffer such that overflow or underflow does not occur in the hypothetical decoder input buffer when encoding the primary and secondary video streams.

15. The non-transitory computer-readable storage media of claim 9, wherein the splice point is denoted by an SCTE35 marker.

16. An apparatus comprising:
one or more processors; and
a non-transitory computer-readable storage medium comprising instructions that, when executed, control the one or more processors to be configured for:
identifying a splice point in a video stream to be encoded to thereby generate an encoded video stream; and
encoding the video stream so that a bit rate of the encoded video stream at the splice point using a hypothetical decoder input buffer model that assigns a predetermined occupancy level to the hypothetical decoder input buffer.

17. The apparatus of claim 16, wherein the video stream is an ABR video stream and the splice points are aligned with ABR segment boundaries.

18. The apparatus of claim 16, wherein the hypothetical decoder input buffer model is a VBV buffer model that prevents buffer overflow or underflow in a decoder buffer of a decoder that conforms to a compression standard used to encode the primary video stream.

19. The apparatus of claim 16, wherein the predetermined occupancy level is 0.25-0.75 of a maximum capacity of the hypothetical decoder input buffer.

20. The apparatus of claim 16, wherein the instructions, when executed, further control the one or more processors to be configured for encoding a secondary video stream using the hypothetical decoder input buffer model that is used to encode the video stream such that the predetermined buffer occupancy level is assigned at a beginning point and end point of the secondary video stream.
